(19) United States
(12) Patent Application Publication
(10) Pub. No.: US 2019/0155408 A1
(43) Pub. Date: May 23, 2019

(54) ELECTRICAL STYLUS TIP AND STYLUS USING THE SAME

(71) Applicant: ADONIT CO., LTD, Taipei City (TW)

(72) Inventors: Yu-Kuang HOU, Taipei City (TW); Yueh-Hua LI, Taipei City (TW); Cheng-Wei FAN, Taipei City (TW); Reinier Bloem, Taipei City (TW)

(21) Appl. No.: 15/817,305

(22) Filed: Nov. 20, 2017

(51) Int. Cl. G06F 3/0354

(52) U.S. Cl. CPC G06F 3/03545

(57) ABSTRACT

An electrical stylus tip and a stylus using the same are provided. The electrical stylus tip includes a metal rod and a plastic covering member. The metal rod has a head portion, an end portion and a body portion. A connection rod is connected between the head portion and the body portion. The plastic covering member and the metal rod are integrally formed by means of insert molding. The plastic covering member includes a conductive element covering the head portion and a non-conductive element covering the body portion, and the conductive element and the non-conductive element are connected to each other. The connection rod is enclosed within the conductive element and the non-conductive element, and the end portion protrudes out of the non-conductive element. Accordingly, signal detection is improved, and accuracy of stylus position detection is improved.

### TECHNICAL FIELD

The present invention relates to a stylus tip and, in particular, to a replaceable electrical stylus tip which enables precise detection of stylus contact with a touch control screen and to a stylus using the electrical stylus tip.

### BACKGROUND

With the development of technology, 3C (computer, communication, consumer electronics) products have gained increasing popularity. 3C products having a touch control interface, such as tablet computers and smart phones, have become mainstream electronic products. The touch control interface typically utilizes a touch screen collaborating with an operation system to provide a graphical operation interface. There are different types of touch screens available in the market, including resistive touch screens, capacitive touch screens, and inductive touch screens.

When a stylus is used with the touch screen, the position of the stylus is detected for performing operations on the touch control operation interface. However, when the stylus obliquely taps the touch screen, the touch position is often not precisely detected. This results in errors in the determined stylus position, and reduces accuracy of positioning, so that operation of the stylus is inconvenient to users. Besides, a stylus tip may be worn out, bent or broken after used in a long time.

In view of this, the inventor studied various technologies and created an effective solution in the present disclosure.

### SUMMARY

It is an objective of the present invention to provide an electrical stylus tip and a stylus using the same for enabling precise detection of the position of the stylus.

It is another objective of the present invention to provide a replaceable electrical stylus tip and a stylus using the same.

Accordingly, the present invention provides an electrical stylus tip, assembled to a barrel, for operating a capacitive touch sensitive device. The electrical stylus tip includes a metal rod and a plastic covering member. The metal rod includes a head portion, an end portion and a body portion connected to the head portion and the end portion. A connection rod is connected between the head portion and the body portion. The plastic covering member includes a conductive element covering the head portion and includes a non-conductive element covering the body portion. The connection rod is enclosed within the conductive element and the non-conductive element, and the end portion protrudes out of the non-conductive element.

Accordingly, the present invention also provides a stylus which includes a barrel and the electrical stylus tip. The electrical stylus tip is assembled to the barrel and is replaceable. The barrel can be conductive or non-conductive, and depending on requirement.

The present invention further has the following functions. In one embodiment, the plastic covering member and the metal rod are integrally formed by insert molding. In other words, the conductive element, the non-conductive element and the metal rod are integrally formed by insert molding. A recess of the metal rod enhances a joining effect between the metal rod and the plastic covering member which are of different materials. A connection rod is disposed passing through the head portion and the body portion. The recess is formed on the connection rod by, for example, lathe cutting the connection rod, so that the plastic covering member can be stably connected and fixed to the metal rod.

A cross-sectional area of the head portion is two times or more the cross-sectional area of the connection rod, so it is more difficult for the connection rod to cause capacitive coupling with a touch screen. In addition to that, a distance from the connection rod to the touch screen is longer than a distance from the electrical stylus tip to the touch screen, so the position of the electrical stylus tip is very close to the coordinates determined by a capacitive touch sensitive device (or a capacitive touch sensitive system). In other words, errors in the determined stylus position are reduced, thus achieving precise coordinate detection and thereby improving user experience.

If the conductive element of the electrical stylus tip has been worn out after being used in a long time or is broken accidentally, a user can detach the old electrical stylus tip from an insertion hole of the barrel, and then connect a new electrical stylus tip to the barrel by threadedly connecting an external threaded portion of the new electrical stylus tip to an internal threaded portion of the barrel. In alternative embodiments, the replaceable electrical stylus tip is detachably joined to the barrel by interference fit or by using a flange engaged with a groove or by other fastening method. The electrical stylus tip is reliable and can be replaced easily, so there is no need to buy a new stylus, which results in considerable cost savings.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a schematic view illustrating a stylus according to the present invention, which is also a schematic view illustrating an electrical stylus tip installed on a barrel of the stylus;

FIG. 2 is a perspective view illustrating a metal rod of the electrical stylus tip according to the present invention;

FIG. 3 is a cross-sectional view illustrating the metal rod of the electrical stylus tip according to the present invention;

FIG. 4 is a cross-sectional view illustrating that the metal rod is integrally formed with the conductive element;

FIG. 5 is a cross-sectional view illustrating that the metal rod is then integrally formed with the non-conductive element;

FIG. 6 is a perspective view illustrating a plastic covering member joined to the metal rod;

FIG. 7 is a cross-sectional view illustrating the electrical stylus tip threadedly connected to the barrel in a detachable and replaceable manner;

FIG. 8A is a diagram illustrating an experiment result about a conventional stylus collaborating with a capacitive touch sensitive device; and

FIG. 8B is a diagram illustrating an experiment result about the stylus collaborating with the capacitive touch sensitive device according to the present invention.

### DETAILED DESCRIPTION

Detailed descriptions and technical contents of the present invention are illustrated below in conjunction with the accompanying drawings. However, it is to be understood that the descriptions and the accompanying drawings disclosed herein are merely illustrative and exemplary and not intended to limit the scope of the present invention.

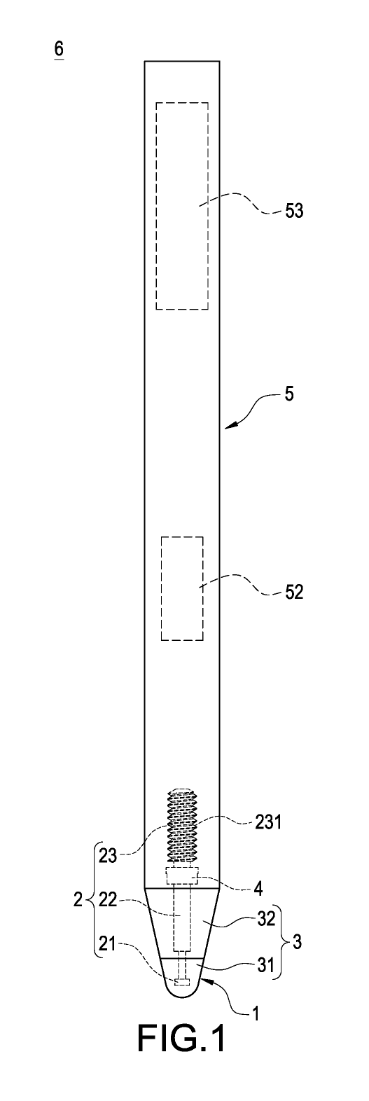

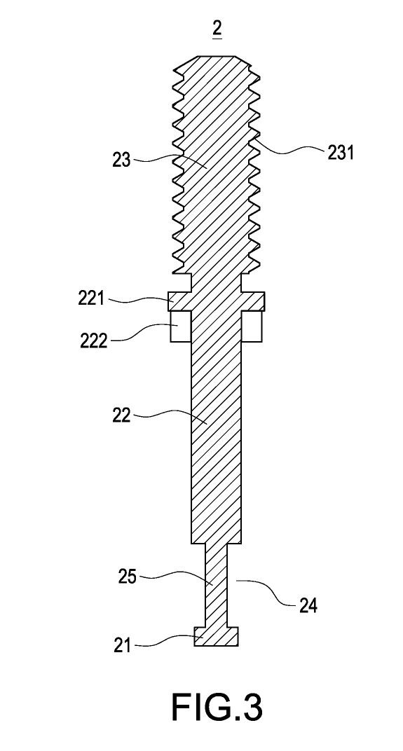

Referring to FIGS. 1 to 6, the present invention provides an electrical stylus tip 1 which is assembled to a barrel 5 to form a stylus 6. In the present embodiment, the stylus 6 is an active stylus which actively transmits or receives signals to perform various functions by touching a touch screen of a capacitive touch sensitive device (not illustrated) such as a computer, a mobile device, a graphics tablet, and other devices. The electrical stylus tip 1 is assembled to the barrel 5 having a power supply or a capacitor. However, in alternative embodiments, the stylus 6 can be a passive stylus or other suitable stylus; the present invention is not limited in this regard.

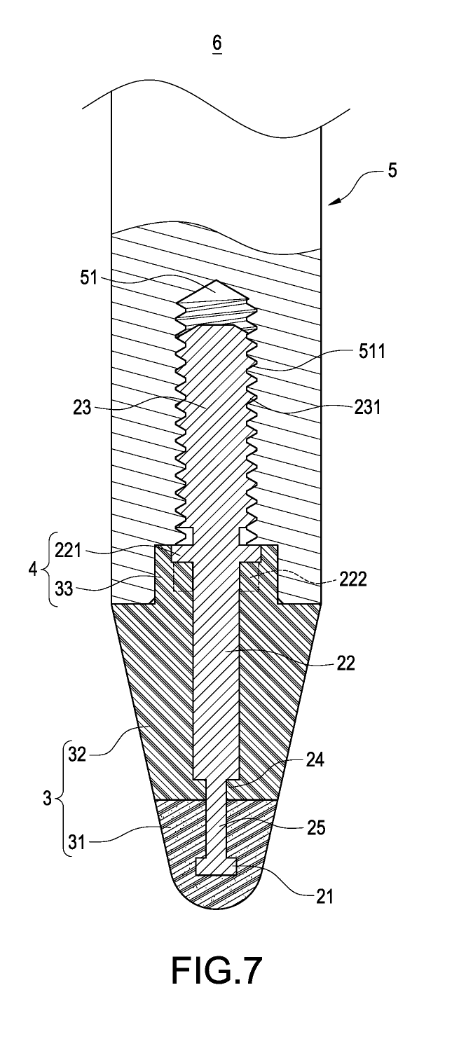

In the embodiment shown in FIG. 1 and FIG. 7, inside the barrel 5 of the active capacitive stylus 6, there include an insertion hole 51, a circuit unit 52 having electrical components such as a capacitor, a power supply unit 53 coupled to the circuit unit 52. The power supply unit 53 is, for example, a dry battery, a storage battery, or a lithium battery, for supplying power to the stylus 6. When the electrical stylus tip 1 touches or comes within proximity of a surface of the capacitive touch sensitive device, a change in the capacitance occurs at the location of stylus touch or proximity such that coordinates of the stylus 6 can be determined. The electrical stylus tip 1 is installed on the barrel 5 and is replaceable. The barrel 5 can be conductive or non-conductive, depending on requirement. The insertion hole 51 of the barrel 5 is detachably assembled to the electrical stylus tip 1, and details of how they are assembled will be described hereinafter.

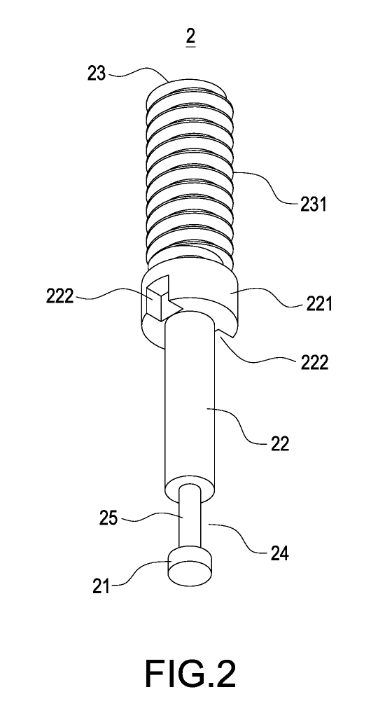

Referring to FIGS. 2 to 6, the electrical stylus tip 1 includes a metal rod 2 and a plastic covering member 3. The metal rod 1 includes a head portion 21, an end portion 23 and a body portion 22 connected to the head portion 21 and the end portion 23. A connection rod 25 is connected between the head portion 21 and the body portion 22. In the present embodiment, the metal rod 2 is preferably a long rod consisting of, but not limited to, iron, steel, copper, alloy thereof, or other conductive materials. One end of the metal rod 2 is fixed to the plastic covering member 3 to support the same. The other end of the metal rod 2 is electrically coupled to the circuit unit 52 of the barrel 5, so that an input signal generated can be transmitted, and then received by the circuit unit 52, and then an output signal is transmitted to the capacitive touch sensitive device, so that the coordinates of the stylus 6 can be determined through the interaction of the stylus 6 with the capacitive touch sensitive device.

The plastic covering member 3 and the metal rod 2 are integrally formed by insert molding, so that the stylus 6 has a wear resistant and elastic contact surface for tapping the capacitive touch sensitive device (not illustrated). The plastic covering member 3 includes a conductive element 31 covering the head portion 21 and includes a non-conductive element 32 covering the body portion 22, the connection rod 25 is disposed inside the conductive element 31 and the non-conductive element 32, the conductive element 31 is connected to the non-conductive element 32, and the end portion 23 protrudes out of the non-conductive element 32.

A recess 24 is formed on the connection rod 25. The recess 24 is an annular recess on the exterior of the connection rod 25. In the present embodiment, the conductive element 31 and the non-conductive element 32 are integrally formed with the metal rod 2 by, preferably, bi-injection molding (insert molding). The recess 24 of the metal rod 2 increases the joining effect between the two different materials of the conductive element 31 and the non-conductive element 32. In the embodiment of FIGS. 2 to 6, the recess 24 is formed on the connection rod 25 of the body portion 22 by, for example, lathe cutting the connection rod 25, so that the plastic covering member 3 can be stably connected and fixed to the metal rod 2. A diameter of the connection rod 25 is less than a diameter of the head portion 21 or a diameter of the body portion 22, so that the plastic covering member 3 is more stably connected to the connection rod 25.

In detail, the head portion 21 is of disc shape, and the connection rod 25 is of cylindrical shape. A cross-sectional area of the head portion 21 is two times or more a cross-sectional area of the connection rod 25. The connection rod 25 partially protrudes from the conductive element 31, i.e. the non-conductive element 32 partially covers the connection rod 25, so that an input signal is generated due to capacitive coupling between the capacitive touch sensitive device and both the head portion 21 and a portion of the connection rod 25 inside the conductive element 31. By contrast, no capacitive coupling/signals occurs between the capacitive touch sensitive device and both the body portion 22 and a portion of the connection rod 25 inside the non-conductive element 32 since the body portion 22 and the portion of the connection rod 25 are enclosed inside the non-conductive element 32 made of a non-conductive material.

Although both the head portion 21 and the portion of the connection rod 25 inside the conductive element 31 cause capacitive coupling with the touch screen, the cross-sectional area of the head portion 21 is two times or more the cross-sectional area of the connection rod 25, so it is more difficult for the connection rod 25 to cause capacitive coupling with the touch screen. In addition, a distance from the connection rod 25 to the touch screen is longer than a distance from an electrical stylus tip 21 to the touch screen, so the position of the electrical stylus tip 1 is very close to the coordinates determined by the capacitive touch sensitive device (i.e. a capacitive touch sensitive system), thereby achieving precise detection of stylus position, thus improving user experience.

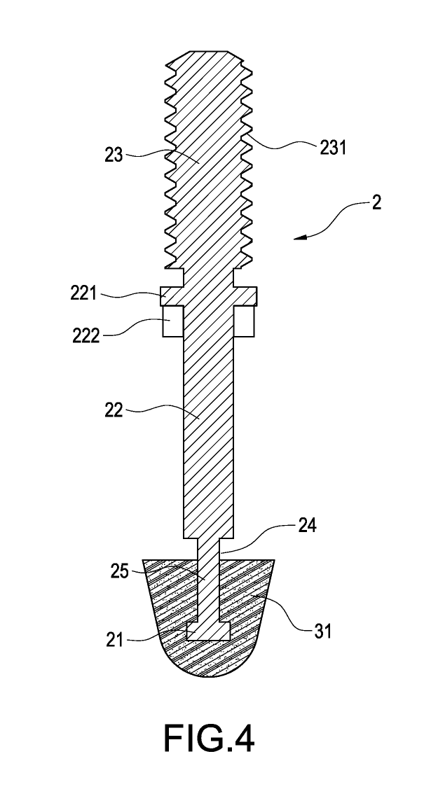

Furthermore, the description below with reference to FIGS. 4 to 6 details how the plastic covering member 3 and the metal rod 2 are integrally formed by insert molding. The metal rod 2, after processed by lathe cutting or by other suitable method, is placed into a mold (not illustrated). A plastic material mixing with metal powders are injected into the mold to form the conductive element 31 which wraps the head portion 21 and a portion of the connection rod 25. After the conductive element 31 is solidified, insert molding is further carried out for forming the non-conductive element 32. When a material such as polyoxymethylene (POM) is injected into the mold, the non-conductive element 32 is connected to the conductive element 31 and wraps a portion of the connection rod 25 to an insertion portion 4. The non-conductive element 32 and the conductive element 31 are reliably joined and fixed by means of the recess 24 and the two cavities 222 on the protruding ring portion 221.

The conductive element 31 can be constituted by POM, i.e. the same plastic material that constitutes the non-conductive element 32. Therefore, the conductive element 31 and the non-conductive element 32 after solidified have proper electrical impedance, hardness, elasticity, and wear resistance on their surface, and also have stable shapes. However, in alternative embodiments, the conductive element 31 and the non-conductive element 32 can consist of polyurethane (PU) or other suitable thermoplastic material, wherein metal powders are mixed into the conductive element 31 consisting of PU.

Furthermore, the conductive element 31 has a length L′ preferably shorter than a length L″ of the non-conductive element 32 along a longitudinal direction of the metal rod 2, so that when the electrical stylus tip 1 obliquely contacts the capacitive touch sensitive device, the head portion 21 inside the conductive element 31 even more effectively causes capacitive coupling with the capacitive touch sensitive device.

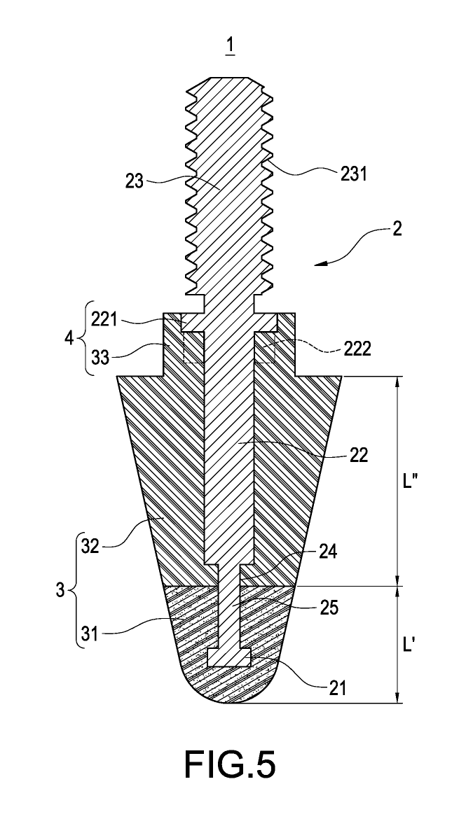

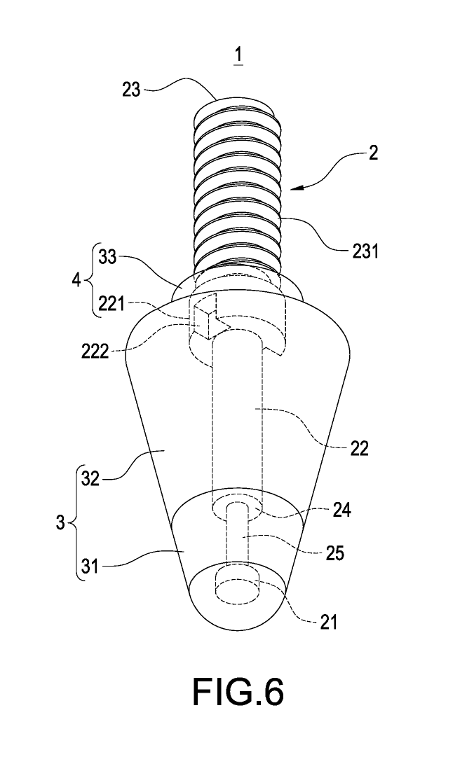

In the embodiment shown in FIGS. 5 and 6, the electrical stylus tip 1 further includes the insertion portion 4, and the insertion portion 4 includes the protruding ring portion 221 surrounding the body portion 22 and includes an extending non-conductive portion 33 covering the protruding ring portion 221. The protruding ring portion 221 includes two cavities 222 arranged opposite to each other and toward the head portion 21, and the extending non-conductive portion 33 is engaged into the two cavities during the insert molding process so as to increase joining strength between the metal rod 2 and the extending non-conductive portion 33/the non-conductive element 32. In the present embodiment, it is preferable that the non-conductive element 33 and the extending non-conductive portion 32 are both formed in the insert molding process to reduce time and production costs.

An exterior surface of the end portion 23 includes an external threaded portion 231, and the external threaded portion 231 is threadedly connected to the barrel 5, so that the electrical stylus tip 1 is replaceable. Referring to FIG. 7, the barrel 5 includes an insertion hole 51 corresponding to the insertion portion 4 and includes an internal threaded portion 511 on an inner surface of the insertion hole 51. If the conductive element 31 of the electrical stylus tip 1 has been worn out after being used in a long time or is broken accidentally, a user can detach the old electrical stylus tip 1 from the insertion hole 51 of the barrel 5, and then connect a new electrical stylus tip 1 to the barrel 5 by threadedly connecting the external threaded portion 231 of the new electrical stylus tip 1 to the internal threaded portion 511 of the barrel 5. In alternative embodiments, the replaceable electrical stylus tip 1 is detachably joined to the barrel 5 by interference fit or by using a flange engaged with a groove or by other fastening method; the present invention is not limited in this regard. The electrical stylus tip 1 is reliable and can be replaced easily, so there is no need to buy a new stylus 6, which results in considerable cost savings.

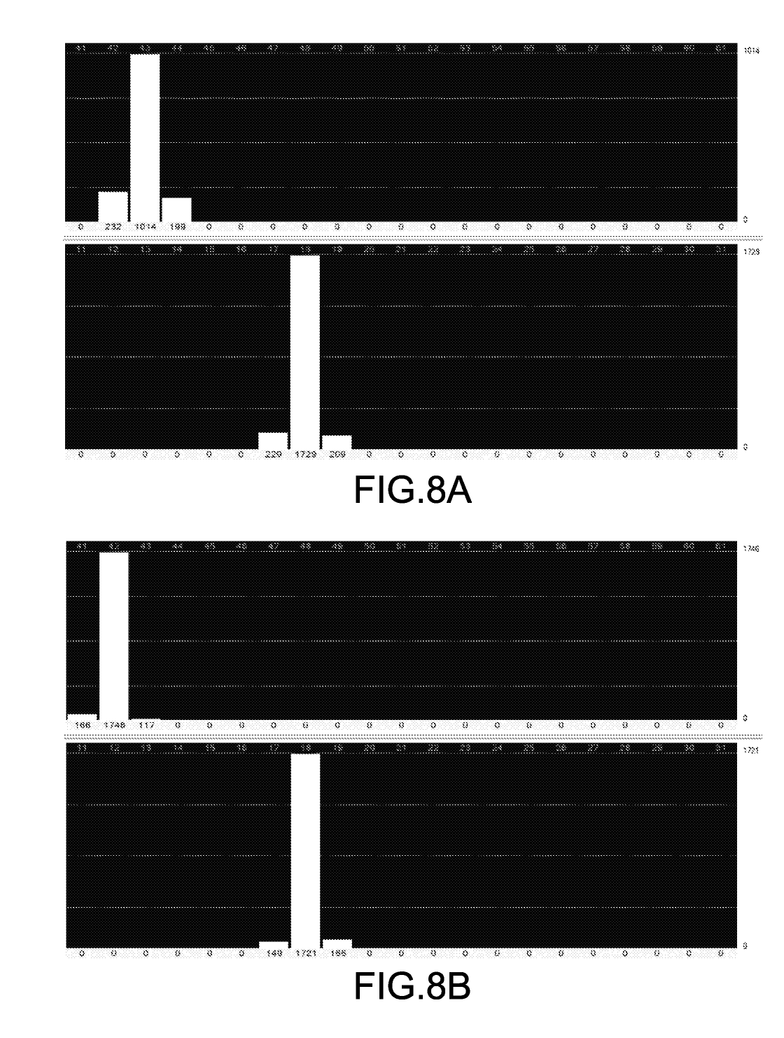

Please refer to FIGS. 8A and 8B, explaining the difference between a conventional stylus and the stylus 6 with the electrical stylus tip 1 when they separately collaborate with a capacitive touch sensitive device (not illustrated). FIG. 8A is a diagram illustrating an experimental result on the conventional stylus (not illustrated) collaborating with the capacitive touch sensitive device. FIG. 8B is a diagram illustrating an experimental result on the stylus 6 collaborating with the capacitive touch sensitive device. In one example embodiment, when the conventional stylus (not illustrated) obliquely touches the capacitive touch sensitive device (not illustrated), the signal strength resulting from capacitive coupling therebetween is 1014 (see the upper part of FIG. 8A). By contrast, when the electrical stylus tip 1 obliquely touches the capacitive touch sensitive device, the signal strength resulting from capacitive coupling therebetween is 1746 (see the upper part of FIG. 8B) which is significantly higher than the signal strength generated by the conventional stylus (not illustrated).

Furthermore, the configuration of the metal rod 2 also reduces the noise (see FIG. 8B at two sides of the signal strength). Referring to the lower parts of FIGS. 8A and 8B, when the stylus 6 with the electrical stylus tip 1 perpendicularly touches the capacitive touch sensitive device, the signal strength does not have a significant difference compared to the conventional stylus, but the noise of the stylus 6 is significantly less than the conventional stylus. Therefore, the electrical stylus tip 1 and the stylus 6 using the same improve signal strength and thereby achieve precise detection of the position of the stylus 6.

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. An electrical stylus tip, assembled to a barrel, the electrical stylus tip comprising:
a metal rod including a head portion, an end portion and a body portion connected to the head portion and the end portion, wherein a connection rod is connected between the head portion and the body portion; and
a plastic covering member including a conductive element covering the head portion and including a non-conductive element covering the body portion, the connection rod being enclosed within the conductive element and the non-conductive element, the conductive element being connected to the non-conductive element, the end portion protruding out of the non-conductive element.

2. The electrical stylus tip according to claim 1, wherein a recess is formed on the connection rod.

3. The electrical stylus tip according to claim 1, wherein a diameter of the connection rod is smaller than a diameter of the head portion, the head portion is of disc shape, and the connection rod is of cylindrical shape.

4. The electrical stylus tip according to claim 1, wherein a cross-sectional area of the head portion is two times or more than a cross-sectional area of the connection rod.

5. The electrical stylus tip according to claim 1, wherein the conductive element has a length shorter than a length of the non-conductive element along a longitudinal direction of the metal rod.

6. The electrical stylus tip according to claim 1, wherein the conductive element consists of a plastic material mixing with metal powders, and the non-conductive element and the plastic material are made of polyoxymethylene.

7. A stylus, comprising:
a barrel; and
an electrical stylus tip, comprising:
a metal rod including a head portion, an end portion and a body portion connected to the head portion and the end portion, wherein a connection rod is connected between the head portion and the body portion; and
a plastic covering member including a conductive element covering the head portion and including a non-conductive element covering the body portion, the connection rod being enclosed within the conductive element and the non-conductive element, the end portion protruding out of the non-conductive element, wherein the electrical stylus tip is assembled to the barrel and is replaceable.

8. The stylus according to claim 7, wherein the electrical stylus tip further includes an insertion portion, and the insertion portion includes a protruding ring portion surrounding the body portion and includes an extending non-conductive portion covering the protruding ring portion.

9. The stylus according to claim 8, wherein the protruding ring portion includes two cavities arranged opposite to each other and toward the head portion, and the extending non-conductive portion is engaged into the two cavities and receives the body portion.

10. The stylus according to claim 8, wherein the barrel includes an insertion hole corresponding to the insertion portion and an internal threaded portion on an inner surface of the insertion hole.

11. The stylus according to claim 10, wherein an exterior surface of the end portion of the electrical stylus tip includes an external threaded portion, and the external threaded portion of the electrical stylus tip is threadedly connected to the internal threaded portion of the barrel.
